(19) United States
(12) Patent Application Publication
(10) Pub. No.: US 2008/0018129 A1
(43) Pub. Date: Jan. 24, 2008

(54) Vehicle protective pad

(76) Inventor: Hermel Pelletier, Greenville, NH (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(21) Appl. No.: 11/491,867

(22) Filed: Jul. 24, 2006

(51) Int. Cl. B60J 9/00

(52) U.S. Cl. 296/1.08

(57) ABSTRACT

A device and system for protecting a vehicle finish are disclosed herein. The exemplary protective guard may include a removably coupled, flexible protective guard sized to fit on top of the vehicle's surface in proximity to the handle. The protective guard may be adhered statically or magnetically. In embodiments, there may be one or more apertures in the protective guard to allow access to the handle and adjacent features, for example, keyholes or access code panels. The protective guard may also be disposable and replaceable.

### FIELD OF THE INVENTION

The present invention pertains to a protective pad for placement on a vehicle.

### BACKGROUND OF THE INVENTION

When grabbing a vehicle's handle, the vehicle's finish around the handle may get scratched by jewelry, finger nails, and keys. Attempting to insert a key into a keyhole near the handle may also result in scratching the vehicle's finish. Scratches in a vehicle's finish can be costly and time-consuming to repair. If left unrepaired, the finish may be unsightly and/or potentially susceptible to rust.

Accordingly, there is a need for a protective guard that will prevent scratches near a vehicle's handle. By making the protective guard replaceable, owners can quickly and easily change them as often as needed or desired.

### SUMMARY

Accordingly, the present invention is a novel system and device for protecting a vehicle's surface around a handle. A removably coupled, flexible, protective guard is sized to fit on top of the vehicle's surface in proximity to the handle.

Embodiments of the invention may have one or more of the following features. According to one exemplary embodiment, the protective guard may be adhered magnetically. According to another exemplary embodiment, the protective guard may be adhered statically. In other exemplary embodiments, the protective guard may be disposable and replaceable. Implementations may include other features; for example, the protective guard may have one or more apertures to allow access to the handle and adjacent features. In other exemplary embodiments, the protective guard may be transparent material or it may have an aesthetic print on its surface. According to another exemplary embodiment, the protective guard may have one or more apertures to allow access to a keyhole. According to another exemplary embodiment, the protective guard may be a static cling, vinyl film.

It is important to note that the present invention is not intended to be limited to a system or method which must satisfy one or more of any stated objects or features of the invention. It is also important to note that the present invention is not limited to the exemplary embodiments described herein. Modifications and substitutions by one of ordinary skill in the art are considered to be within the scope of the present invention, which is not to be limited except by the following claims.

### BRIEF DESCRIPTION OF THE DRAWINGS

These and other features and advantages of the present invention will be better understood by reading the following detailed description, taken together with the drawings wherein:

FIG. 1A is a protective guard according to a first exemplary embodiment used to implement the present invention.

FIG. 1B is the protective guard according to the first exemplary embodiment coupled to a car door handle.

FIG. 2A is a protective guard according to a second exemplary embodiment used to implement the present invention.

FIG. 2B is the protective guard according to the second exemplary embodiment coupled to a car door handle.

FIG. 3A is a protective guard according to a third exemplary embodiment used to implement the present invention.

FIG. 3B is the protective guard according to the third exemplary embodiment coupled to a car door handle.

### DETAILED DESCRIPTION

The invention provides a guard that is designed to protect a vehicle's surface around a handle while allowing access to the handle and all adjacent features. The protective guard may be removably coupled so that a user can easily remove and replace the guard. The shape of the protective guard may be determined by the vehicle's design around the handle and the accessories located in proximity to the handle. The accessories may include, for example, but are not be limited to a keyhole or an access code panel. The protective guard is positioned on top of the vehicle's surface surrounding a handle. The protective guard then provides a layer of protection against scratches due to fingernails, keys, jewelry, or a variety of other objects in hand while the user attempts to open, lock, or unlock a vehicle door.

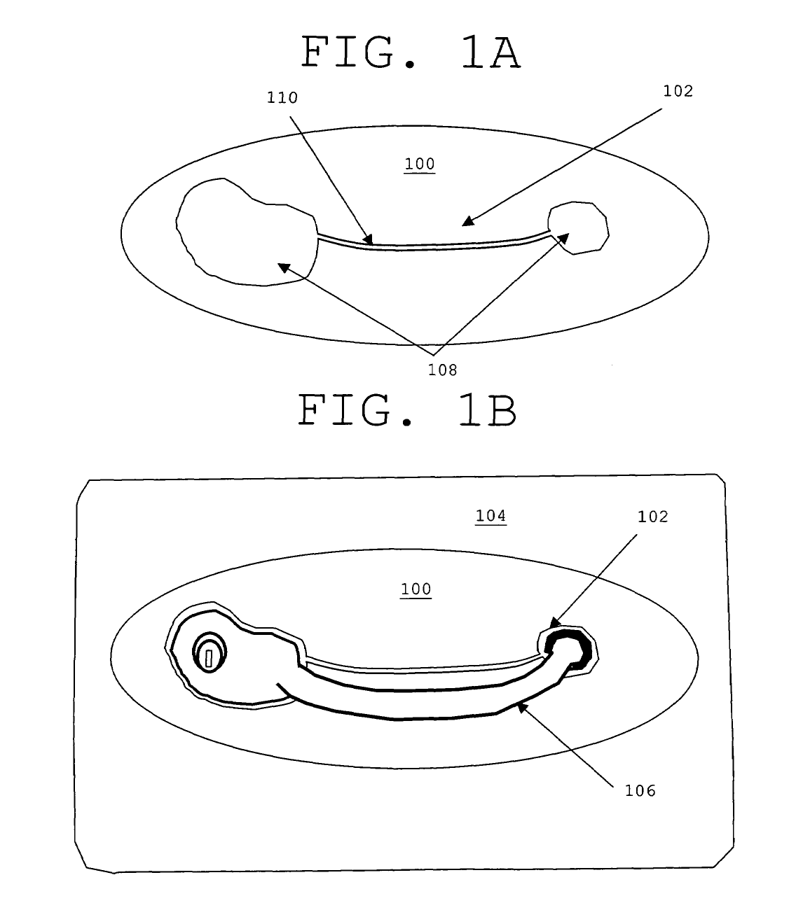

Referring to FIGS. 1A and 1B, a protective guard 100, according to the first exemplary embodiment, may have an aperture 102 to allow for easy application and maximum surface protection. The protective guard 100 may be removably coupled to a vehicle surface 104 surrounding a vehicle handle 106. In this exemplary embodiment, the aperture 102 consists of two handle openings 108 at either end, which are joined by a slit 110. The two handle openings 108 in the aperture 102 are shaped to fit around each fixed end of the vehicle handle 106. The exact shape of the aperture 102 may be designed to fit closely around any specific handle. The size and shape of the protective guard may vary with different vehicles and even different handles on the same vehicle. The slit 110 in the handle openings 108 allows the user to quickly and easily slide the protective guard 100 over the handle 106. With the handle 106 sliding easily through the slit 110 in the aperture 102, the protective guard 100 is then easily coupled to the vehicle surface 104. If necessary, the protective guard 100 may be pressed smooth against the vehicle surface 104, and the installation may be complete.

The protective guard 100 may be coupled to a vehicle's surface statically. In this case, the protective guard 100 may be made of a highly plasticized vinyl film designed to adhere to a smooth relatively non-porous surface. An example would be a static cling vinyl film manufactured by Gerber Scientific Products, Inc. of South Windsor, Conn. The material may be transparent or solid colored, or it may have an aesthetic print on a front surface of the guard 100. The thickness of such a static cling vinyl film may be about 7 or 8 mils. A UV protective layer may be added to the film to prevent or minimize fading. The protective guard 100 may be produced in standard sheet for a variety of models of vehicles. A user may select from multiple patterns printed on the sheet for various vehicle models. The user cuts along the pattern for the desired specific vehicle model to provide a customized shape for a specific vehicle. The sheet may also include a variety of designs for the user to select and personalize their vehicle.

The protective guard 100 may be coupled to the vehicle's surface magnetically. In this case, the protective guard 100 may be made of a flexible magnetic material. An example may be a material like GerberMag manufactured by Gerber Scientific Products, Inc. of South Windsor, Conn. Again, the material may be solid colored or the material may have an aesthetic print on a front surface of the material. The thickness of such a flexible magnetic material may be about 18-20 mils. A UV protective layer may also be added to the material to prevent or minimize fading. It is also possible that the protective guard may be made of a combination of materials. This may be useful with indented vehicle surfaces, which extend up and under a handle (as discussed in greater detail in the second and third exemplary embodiments).

The length and height of the protective guard 100 may be designed based on the size and shape of the handle and whether or not other adjacent features are present. Features below or above the handle and features to one side or the other of the handle may be used to determine the dimensions of the protective guard 100.

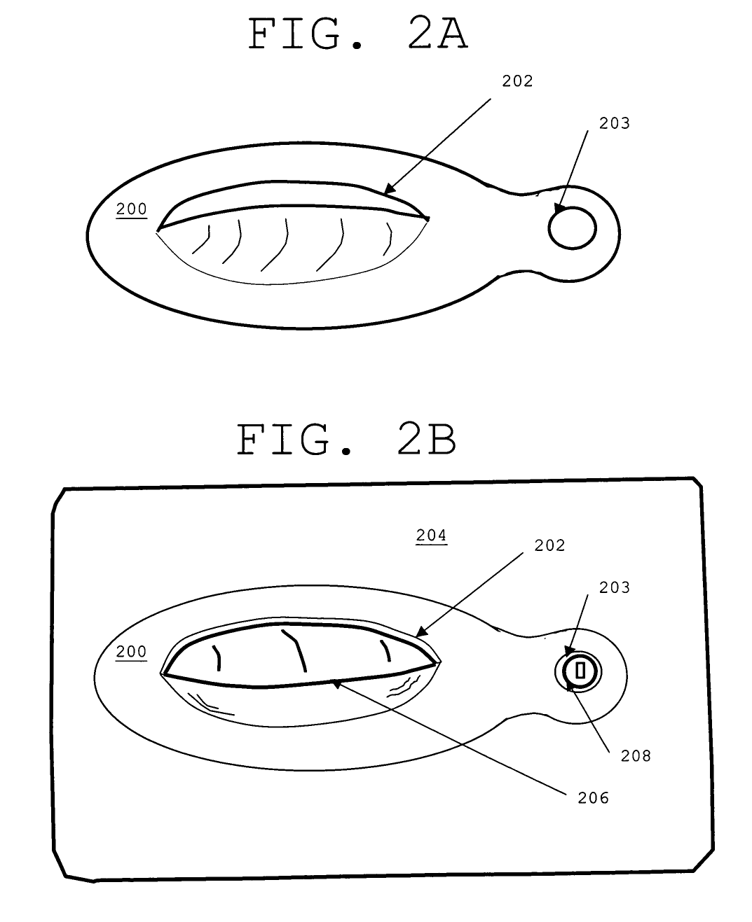

Referring to FIGS. 2A and 2B, a protective guard 200, according to a second exemplary embodiment, has a handle aperture 202 for a vehicle handle 206 and a keyhole aperture 203 for a keyhole 208 which is in proximity to the vehicle handle 206. The protective guard 200 may be removably coupled to a vehicle's surface 204 surrounding the vehicle handle 206 and the keyhole 208. In this exemplary embodiment, the protective guard 200 is shaped to provide protection to the vehicle surface 204 around and in between the vehicle handle 206 and the keyhole 208. The protective guard 200 may provide protection to the vehicle surface 204, which extends up and under the handle 206. This area of the vehicle surface 204 may be flush with the surrounding surface or it may be slightly indented. To allow the protective guard 200 to adhere properly to an indented surface, the material used may be a combination of a more rigid or semi-rigid, possibly molded plastic portion coupled with a flexible static or magnetic portion. These two portions may be coupled with adhesive to produce a one-piece protective guard for certain applications.

The protective guard 200 may also be made of a variety of materials, for example, static cling vinyl film, flexible magnetic material, or a combination including a rigid or semi-rigid molded plastic portion (as mentioned above). Depending on the specific vehicle, the shape and design of the protective guard may vary. In addition to door handles, the protective guard may also be used on trunk handles or various other storage compartment handles. Some examples include, but are not limited to, door and compartment handles on campers, trucks, watercraft, ATV's, and golf carts. Other features may also be present in other embodiments including an access code panel (i.e. keyless entry) in the place of a keyhole. In this case, the protective guard may include one aperture shaped to fit around the access code panel and a separate aperture shaped to fit around a handle.

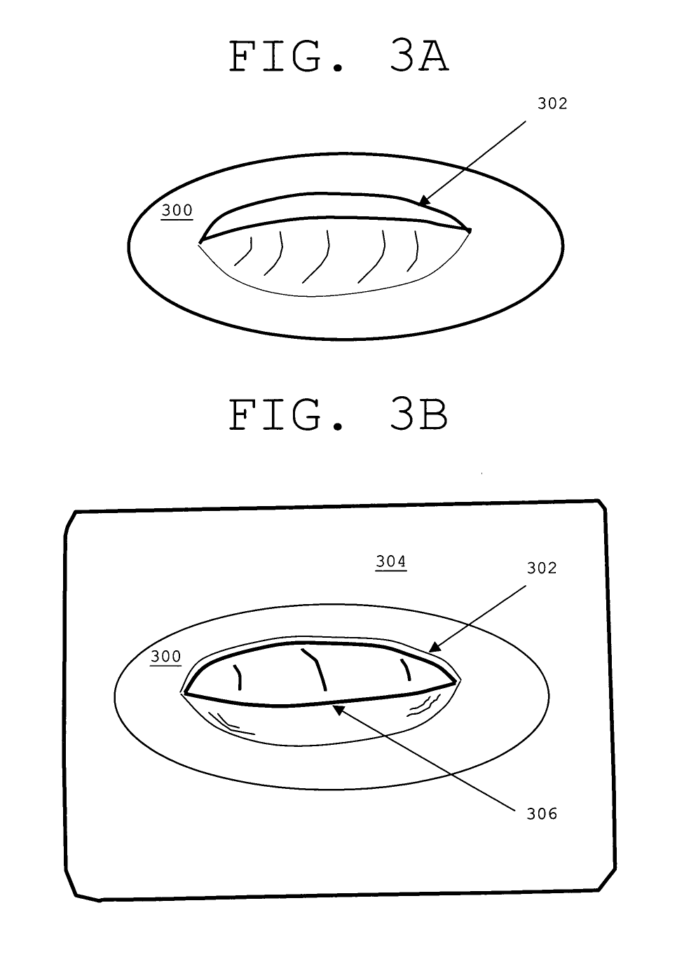

Referring to FIGS. 3A and 3B, a protective guard 300, according to a third exemplary embodiment, has an aperture 302 to allow for easy application and maximum surface protection. The protective guard 300 may be removably coupled to a vehicle's surface 304 surrounding the handle 306. The protective guard 300 may also provide protection to the vehicle surface 304, which extends up and under the handle 306. This area of the surface may be flush with the surrounding surface or it may be slightly indented. The protective guard 300 may be made of a variety of materials, for example, static cling vinyl film, flexible magnetic material, or a combination including a rigid or semi-rigid molded plastic portion.

To apply a protective guard to a vehicle surface, the user may first clean the surface around the handle with soap and water. If the protective guards are produced multiply on a sheet then the user selects the desired guard. Any backing on the protective guard would be removed and the protective guard would be placed so that the vehicle handle slides through the handle aperture. Once the handle is through, the user aligns any apertures with their corresponding features on the vehicle. Then the protective guard is simply smoothed into place.

To remove and/or replace an existing protective guard from a vehicle, merely peel an edge up and pull off the protective guard. The handle slides through the aperture and the surface may be ready to apply a new and/or different protective guard. The surface finish of the vehicle is not damaged or marred in any way by the removal of the protective guard. Complete installation may require no tools and may be finished within seconds.

It will be understood that the foregoing is only illustrative of the principles of the invention and that various modifications can be made by those skilled in the art without departing from the scope and spirit of the invention. Accordingly, such embodiments will be recognized as within the scope of the present invention. Various aspects disclosed in the exemplary embodiments may be incorporated with aspects disclosed in other exemplary embodiments without departing from the scope of the invention.

Persons skilled in the art will also appreciate that the present invention can be practiced by other than the described embodiments, which are presented for purposes of illustration rather than of limitation and that the present invention is limited only by the claims that follow.

What is claimed is:

1. A device for protecting a vehicle's surface around a handle comprising:
a removably coupled, flexible protective guard sized to fit on top of the surface in proximity to the handle.

2. The device of claim 1, wherein the protective guard is adhered magnetically.

3. The device of claim 1, wherein the protective guard is adhered statically.

4. The device of claim 1, wherein the protective guard is disposable and replaceable.

5. The device of claim 1, further comprising one or more apertures in the protective guard to allow access to the handle and adjacent features.

6. The device of claim 1, further comprising an aperture in the protective guard to allow access to a keyhole.

7. The device of claim 1, wherein the protective guard is a static cling, vinyl film.

8. The device of claim 1, wherein the protective guard is transparent material.

9. The device of claim 1, wherein the protective guard has an aesthetic print on its surface.

10. A disposable pad for protecting a vehicle's surface around a handle comprising:
a vinyl film with an aperture sized to fit around the handle and statically clinging to a painted car surface extending around the handle.

11. The device of claim 10, further comprising one or more apertures in the disposable pad to allow access to the handle and adjacent features.

12. The device of claim 10, further comprising an aperture in the disposable pad to allow access to a keyhole.

13. The device of claim 10, wherein the disposable pad is transparent material.

14. The device of claim 10, wherein the disposable pad has an aesthetic print on its surface.
